(19) United States
(12) Patent Application Publication
(10) Pub. No.: US 2009/0049678 A1
(43) Pub. Date: Feb. 26, 2009

(54) METHOD AND APPARATUS FOR PRODUCING A WINDING FOR ELECTRICAL MACHINES

(76) Inventors: Klaus Pflueger, Eberdingen (DE); Martin Henne, Moeglingen (DE); Eberhard Rau, Korntal-Muenchingen (DE)

Correspondence Address: MICHAEL J. STRIKER, 103 EAST NECK ROAD, HUNTINGTON, NY, 11743, US

(21) Appl. No.: 12/088,744

(22) PCT Filed: Sep. 14, 2006
(86) PCT No.: PCT/EP06/66344

§ 371 Date: Jul. 15, 2008

(30) Foreign Application Priority Data
Sep. 30, 2005 (DE) 10 2005 048 094.2

(51) Int. Cl. H02K 15/04

(52) U.S. Cl. 29/596; 29/598; 310/254

(57) ABSTRACT

The invention relates to an electrical machine having a stator winding, its manufacturing method and manufacturing apparatus, wherein the winding is manufactured with a predetermined number of coils on automated winding machines and is then embossed in the region of the longitudinal sides of the coils such that the longitudinal sides (17b), which have a plurality of conductors, of the coils (17), in terms of their cross section, are pressed and deformed into the subsequent slot shape. In order to achieve an extent of the coil conductors (18) without any intersections in the region of the longitudinal sides (17b) of the coils, the invention proposes first inserting the coils (17) in a preliminary embossing station (25) with their longitudinal sides into embossing chambers (23) of an embossing die (20), whose width corresponds to the width of at least two adjacent conductors, wherein the embossing chambers are then closed by an embossing stamp (26) to such an extent that, in the process, the conductors are aligned parallel to one another without any deformation of the cross section, before they are embossed into the final slot shape in a subsequent embossing station.

The invention relates to a method and an apparatus for producing a winding for electrical machines as generically defined by the preambles to claims 1 and 7, and to an electrical machine with a winding produced by that method.

### PRIOR ART

From International Patent Disclosure WO 01/54 25 4 A1, a method for producing the winding of electrical machines in accordance with the preamble to claim 1 is already known. In it, the coils of a three-phase stator winding of the machine are prefabricated in three separately produced, continuously wound winding phases. The coils are later inserted with their longitudinal sides in slots of a stator lamination packet that is initially stretched out flat, using so-called flat-packet technology, and the packet is then along with the winding bent into a ring with slot openings located on the inside and is fixed. If the best possible power-to-weight ratio is to be attained, a high slot filling factor must be achieved. To that end, in a known manner, the coil conductors of each slot are pressed into the slot shape in a stamping station and in the process reshaped in their cross section, before the winding is inserted into the slots of the flat stator lamination packet. In that process, the coils are slightly deformed in the winding head region as well.

Since after the winding of the coils the individual wire windings spring open to a variously pronounced degree because of the bending elasticity of the winding wire, the conductors in the stamping station are often crossed one above the other in the region of the longitudinal sides of coils, and as a consequence, as a result of the stamping operation, the conductors in their crossing portions become severely deformed in cross section or even squeezed and constricted. In later use of the electrical machine, this can cause locally excessive heating to the extent of winding-to-frame short circuiting.

It is an object of the present invention, in stamping of the coil cross sections into the respective slot shape of the stator lamination packet, to avoid crossings of the conductors, located side by side and one above the other, in the region of the longitudinal sides of coils.

### ADVANTAGES OF THE INVENTION

The method according to the invention having the definitive characteristics of claim 1 and the apparatus according to the invention used for it having the definitive characteristics of claim 7 have the advantage that with the parallel alignment of the coil conductors in the region of the longitudinal sides of coils in the stamping chambers of the pre-stamping station, wire crossings are largely avoided or are shifted into the winding heads on both sides. As a consequence, the cross-sectional deformations of the conductors into the respective slot shape in the post-stamping station are lessened, without worsening the slot fill factor. As a result, the risk of damage to the enamel insulation of the winding wire is reduced as well, and squeezing of the winding wire is avoided. A further advantage is considered to be that because there is deformation of the coil conductor cross sections, the phase resistance of the individual coil phases is reduced and hence the efficiency and power-to-weight ratio of the machine are improved.

By the provisions recited in the dependent claims, expedient embodiments and refinements of the characteristics recited in claims 1 and 7 are attained.

To facilitate the later bending of the stator lamination packet, with the winding inserted in it, into a circle, it is especially expedient if on the winding heads of the coils, conductors projecting variously far are deformed in the pre-stamping station in the same operation or the subsequent operation in such a way that the winding head thickness of the individual coils is reduced to approximately half the depth of the slot. Thus the individual winding phases can be more easily fitted into one another and reshaped together with the stator lamination packet into a winding head ring. Moreover, especially in the embodiment of a single-layer lap winding, the advantage of flat winding heads is attained if the coils of preferably three winding phases, offset from one another and each continuously wound, of the winding are successively placed in the stamping chambers and deformed in such a way that the conductors in the stamping chambers are aligned parallel to one another, preferably resting in pairs on one another, and the winding heads of the coils, in the regions where they cross, are each internested inside one another. Expediently, to that end, after the insertion of each winding phase into the stamping chambers, the conductors of the coils of this winding phase are aligned in the region of the longitudinal sides of coils and are deformed and internested in the region of the winding heads. Thus only after being prestamped three times is a three-phase stator winding completely prestamped. Virtually the same result can be attained in a shortened and simpler way, however, by providing that after the coils of all the winding phases have been placed in the stamping chambers, the coil conductors are aligned jointly in the region of the longitudinal sides of coils and are deformed and internested in the region of the winding heads.

Since in a multi-phase winding the various winding phases are placed in succession in the stamping chambers of the pre-stamping station, they necessarily rest at various heights in the stamping chambers; in other words, the conductors of the first winding phase are placed in the lower region of the stamping chambers, the conductors of the second winding phase are placed in the middle region, and those of the third winding phase are placed in the upper region of the stamping chambers, before the stamping die moves into the stamping chambers. In order now to be able to align all the conductors in the stamping chambers parallel with one another if at all possible at the onset of the lowering of the stamping die, it is proposed in a refinement of the invention that the bottoms of the stamping chambers, before the coils of the three winding phases located in different levels one above the other are inserted, are first kept at a suitably graduated height and then only upon the alignment of the longitudinal sides of coils and the deformation of the winding heads by stamping strips of the stamping die in the stamping chambers are they lowered to a common lower level.

For parallel alignment of the conductors in the region of the longitudinal sides of coils of the winding, the apparatus of the pre-stamping station is expediently designed such that in a comblike stamping matrix with stamping chambers located side by side, the length of which chambers is at least equivalent to the width of the stator lamination packet, these stamping chambers for the longitudinal sides of the winding are located between upright comb plates that are parallel to one another; the width of the stamping chambers is equivalent to the width of a plurality of coil conductors side by side, preferably two of them, and the height the stamping chambers is equivalent to a multiple of the height, preferably more then three times the height, of conductors of one coil that rest on one another. The stamping chambers are closed at the bottom each by a respective bottom and are open at the top for the insertion of the longitudinal sides of coils; a stamping die can be introduced from above into the stamping chambers and can be lowered into the respective stamping chamber for parallel alignment of the conductors. In a simple way, stamping strips for the stamping chambers are secured to a common yoke of the stamping die, and after the coils have been placed in the stamping chambers the stamping die can be positioned above the stamping plate and lowered in the stamping direction for prestamping the coils. Moreover, to attain a compact winding head, a stop strip is advantageously located on each side of the winding head of the stamping matrix in such a way that it axially fixes the longest of each of the variously far-projecting windings of the coils, and the shortest winding of each is centered and axially fixed by the length of the stamping chambers. For optimal deformation of the winding head in the pre-stamping station with the internested, intertwined winding wires, one holding-down strip is advantageously located on each of the face ends of the stamping strips of the stamping die that on both sides extend somewhat past the stamping chambers.

In a refinement of the invention, it is also provided that the bottoms of the stamping chambers in the outset state can preferably be resiliently pushed upward as far as the upper region of the stamping chambers, and upon the insertion of the coils can first be partially lowered and upon prestamping of the coils can be lowered by means of the stamping die down to a common lower level. As a result, from the outset, the bottoms of the stamping chambers exert a holding function on the coil wires in the slot region, for the sake of a controlled position of the coil wires inside the stamping chamber, both relative to one another and together. In other words, in the slot region the coil wires have no freedom of motion, even if the coil wires are deformed in the winding head region in the pre-stamping station.

### DRAWINGS

The invention will be described in further detail below in examples in conjunction with the drawings. Shown are:

FIG. 1, an electrical machine in longitudinal section, whose stator winding is produced by the method of the invention;

FIG. 2, the prefabricated, continuously wound coils of a winding phase in a three-dimensional view;

FIG. 3, a cross section through a coil along the line III-III of FIG. 2;

FIG. 4 shows the stamping matrix of a pre-stamping station for the stator winding of the machine of FIG. 1 in a three-dimensional view;

FIG. 5 shows the stamping matrix with the coils of three winding phases in place, in a side view;

FIG. 6 shows the stamping matrix in the view along the line VI-VI of FIG. 5;

FIG. 7 shows the pre-stamping station with the stamping die located above the stamping matrix, in part before and in part after the prestamping of the winding;

FIG. 8 shows the pre-stamping station in cross section along the line VIII-VIII of FIG. 7;

FIG. 9 shows a fragment of a stamping chamber of the stamping matrix with loosely inserted conductors in cross section and in an enlarged view; and

FIG. 10 shows the same fragment after the prestamping of the winding, with the conductors of one longitudinal side of a coil in order and located side by side and one above the other.

FIG. 11 shows a fragment of a post-stamping station upon stamping of the conductors of the longitudinal sides of coils to the final slot shape.

FIG. 12, a second exemplary embodiment, shows the pre-stamping station with a first winding phase partially in place and partially prestamped;

FIG. 13 shows the same embodiment with a second winding phase; and

FIG. 14, the same embodiment with a third winding phase, partially after the insertion and partially after the prestamping, partially in cross section.

FIG. 15, in a further exemplary embodiment, shows the stamping matrix and a base plate located beneath it with resiliently displaceable bottom plates for the stamping chamber;

FIG. 16 shows a fragment of the stamping matrix of FIG. 15 in a front-end view, with bottom plates thrust upward into the stamping chambers;

FIG. 17 shows the fragment of FIG. 16, now in cross section with three inserted winding phases before the prestamping; and

FIG. 18 show shows the same fragment as FIG. 17, with the stamping die lowered and with a prestamped winding.

### DESCRIPTION OF THE EXEMPLARY EMBODIMENTS

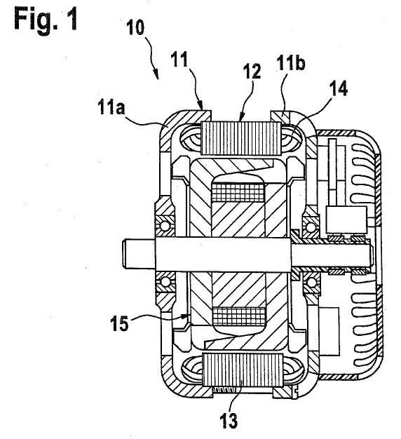

FIG. 1, in a simplified form, shows an electrical machine 10 in longitudinal section that is embodied as a rotary current generator for use in motor vehicles. It has a stator 12, fastened between two bearing flanges 11a, 11b, and this stator comprises a lamination packet 13 and a three-phase stator winding 14 located in the lamination packet. The stator winding 14 is accommodated in slots of the lamination packet 13 that extend axially parallel to one another and are open radially on the inside. Inside the cylindrical lamination packet 13, a claw pole rotor 15 is disposed and rotatably supported in the bearing flanges 11a, 11b.

In the production of the electrical machine, and especially for producing the stator 12, new trails have recently been blazed, in which the lamination packet 13 is first produced as a block-shaped flat packet, with slots open on one side. The stator winding 14 is then first produced with a predetermined number of coils of a plurality of winding phases with a predetermined number of windings on an automated winder and after that stamped into the final slot cross section for the slots of the lamination packet 13 in the region of the longitudinal sides of coils; the conductors are more or less deformed in cross section in the region of the longitudinal sides of coils and curved in the region of the winding heads. The thus-prefabricated stator winding 14 is then inserted in a known manner through the slot openings into the slots of the flat lamination packet 13, before the entire assembly is then rolled into a cylindrical ring or bent into a circle into the final form of the stator 12.

In FIG. 2, one of the three winding phases of the stator winding 14 is shown in three dimensions and marked 16. The winding phase 16 here comprises six coils 17, which have been continuously wound on an automated winder in the form of a so-called single-layer lap winding. Here, the coils 17 are produced with conductors 18 resting in pairs side by side and made of enamel-insulated winding wire of round cross section, and the parallel conductors 18 are each transferred from the upper winding of one coil to the lower winding of the next coil 17. At the coil transitions 17a thus formed, the two winding wires cross one another because of the winding technique. Since after the continuous winding of the winding phase 16, the individual conductors of the coil windings still spring open elastically, further crossings of the conductors 18 also occur inside the individual coils 17 of the winding phase 16 as well as in the region of the longitudinal sides of coils. At the longitudinal sides 17b of the coils 17, the conductors 18 rest loosely side by side and one above the other with interstices between them. They extend essentially parallel to one another.

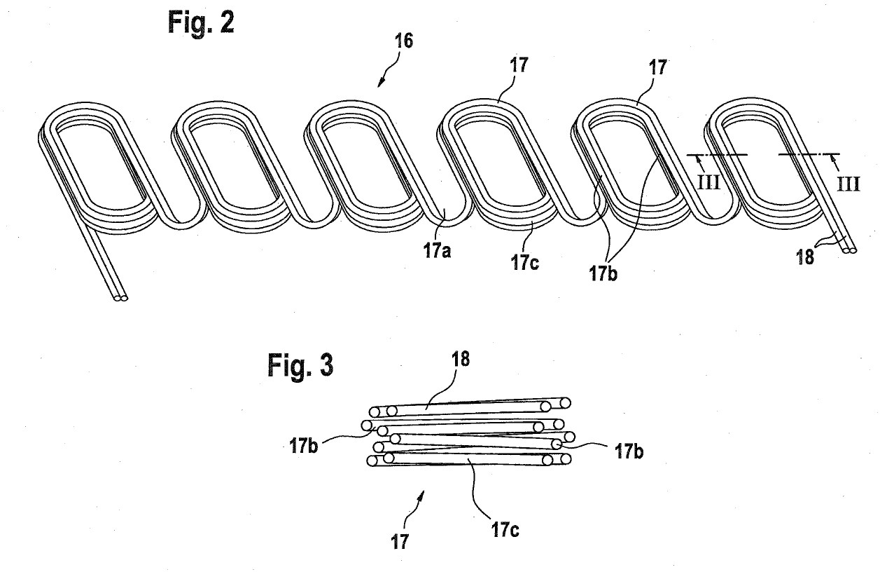

FIG. 3 shows one such arrangement of the conductors 18 of a coil 17 in the region of the longitudinal sides 17b of coils in cross section along the line III-III in FIG. 2. On their two winding heads 17c, the coils 17 have various degrees of projection, since the first lower two windings of the paired conductors at the winding heads 17c protrude farther, by approximately twice the diameter of the winding wire, than the next two, upper windings of the pairs of conductors. It is thus possible for the thickness of the winding heads 17c to be reduced later by deformation.

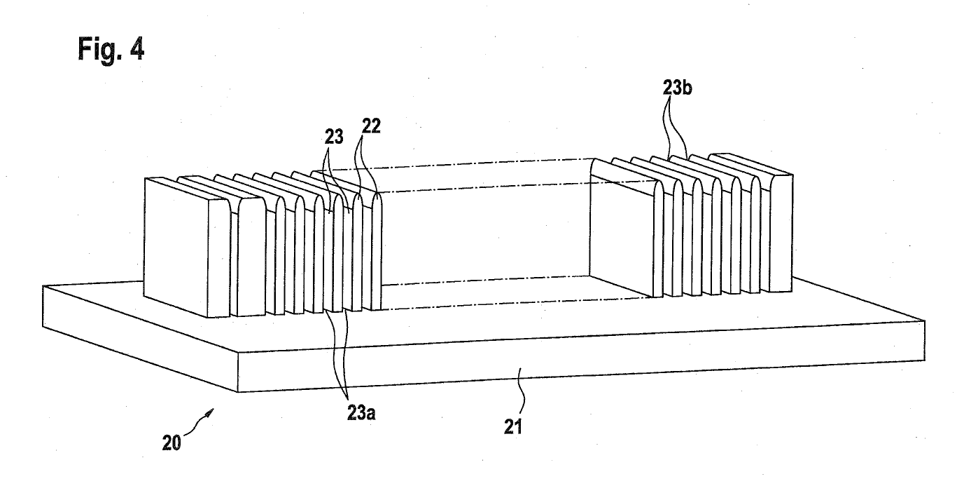

In FIG. 4, a stamping matrix of a pre-stamping station can be seen in a three-dimensional view; with it, the conductors 18 of the stator winding 14 are to be aligned parallel with one another in the region of the longitudinal sides 17b of coils and are to be reshaped by bending in the region of the winding heads 17c. The comblike stamping matrix 20 comprises an elongated stamping plate 21, on which many comb plates 22, extending parallel to one another, are secured standing upright. Between the spaced-apart comb plates 22, there are stamping chambers 23 correspondingly extending parallel to one another and side by side for receiving the longitudinal sides 17b of all the coils 17 of the stator winding 14. The length of the stamping chambers 13 is chosen to be somewhat greater than the width of the lamination packet 13 of the electrical machine 10. This length is determined by the length of the comb plates 22, which is dimensioned such that upon placement of the coils 17, it centers and axially fixes the upper, shorter windings. The width of the stamping chambers 23 is selected such that there is room for only two conductors of the coils 17 side by side. The height of the stamping chambers 23 is selected to be greater than the height of pairs of conductors 18, resting on one another, of three coils. The stamping chambers 23 are closed at the bottom by bottoms 23a of the stamping plate 21 and in the upper region are provided with slightly widened openings 23b for insertion of the longitudinal sides 17b of coils, so that the conductors can be threaded into them better.

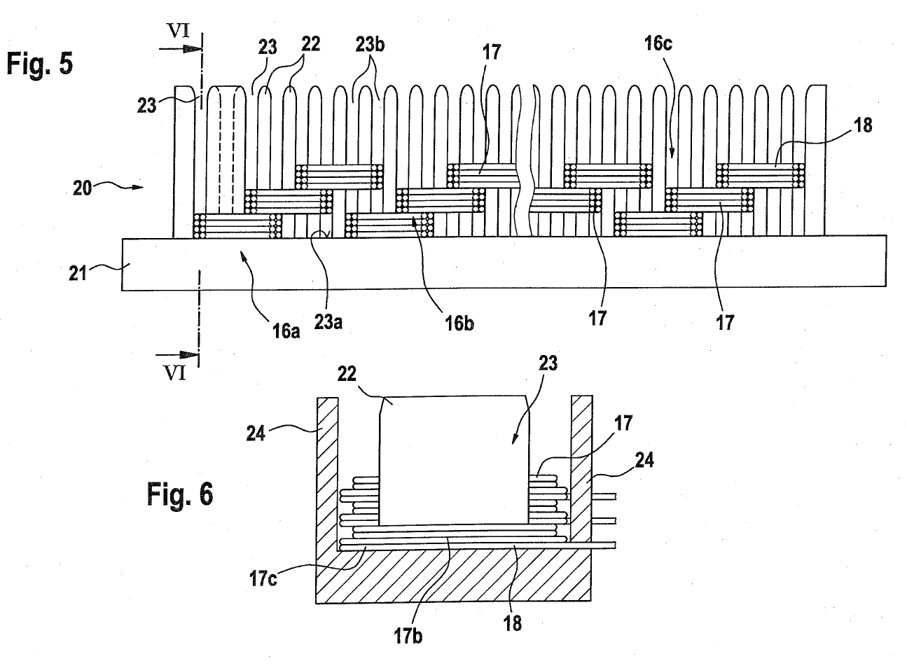

FIGS. 5 through 10, in a first exemplary embodiment of the invention, show a prestamping of the stator winding 14 of the electrical machine 10 for parallel alignment of the longitudinal sides 17b of coils without cross-sectional deformation of the conductors 18. FIG. 5 shows the stamping matrix 20 in a front-end view, with the coils of three winding phases 16a, 16b, and 16c inserted into the stamping chambers 23. All three winding phases are produced separately, as shown in FIG. 2, with their continuously wound coils 17 by automated winders and are inserted in succession into the stamping chambers 23. In that process, the coils 17 of the first winding phase 16a are first loosely placed in the stamping chambers 23, so that their lower winding is braced on the bottom 23a of the stamping chambers. The coil on the left is located with its left-hand longitudinal side in the first stamping chamber 23 on the left. Next, the coils of the second winding phase 16b are placed, offset to the right by two stamping chambers 23 each, and here the coils 17 are braced solely in the region of their winding heads on those of the first winding phase 16a. Finally, the coils 17 of the third winding phase 16c are also inserted, offset to the right by two chambers, into the stamping chambers 23, which in the same are braced solely in the region of their winding heads 17c on the winding heads of the second winding phase 16b. The coils of the three winding phases thus rest in three levels one above the other, and the conductors of the second and third winding phases are freely suspended in air in the region of the longitudinal sides of coils.

FIG. 6 shows a side view of the stamping matrix 20 with the coils inserted into it of the three winding phases 16, in a cross section along the line VI-VI in FIG. 5. It can also be seen here that the lower two layers of the respective coil windings project farther in the region of the winding heads 17c than the layers located above them of the coils 17. While the windings of the coils 17 that do not project as far are centered and axially fixed by the length of the stamping chambers 23 or comb plates 22 in the stamping chambers 23, a stop strip 24 is mounted on each side of the winding head of the stamping matrix 20 in such a way that it axially fixes the windings that project farther of the coils 17.

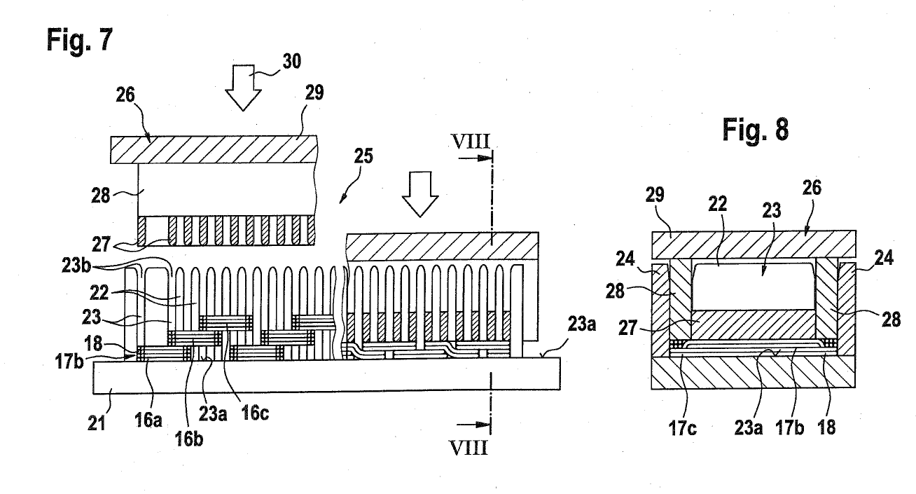

FIG. 7 shows the pre-stamping station as an apparatus 25 for aligning the conductors 18 parallel in the region of the longitudinal sides 17b of coils and for nesting the coil winding heads 17c in one another. In the left half of FIG. 7, the stamping matrix 20 is shown, with the three winding phases 16a, 16b and 16c of FIG. 5 placed in it; now, a stamping die 26 is positioned above the stamping matrix and has many downward-oriented stamping strips 27 extending parallel to one another, which are each located above the stamping chambers 23. The stamping strips 27 on their two face ends are each secured to a holding-down strip 28, which are located on the underside of a yoke 29 of the stamping die 26 and are positioned above the winding heads 17c of the coils 17. The stamping die is lowered from this position in the direction of the arrow 30, and in the process the stamping strips 27 are introduced into the openings 23b in the stamping chambers 23 and in them are then lowered down to their lower position shown in the right half of FIG. 7. In FIG. 8, the apparatus 25 is shown again in cross section, taken along the line VIII-VIII in FIG. 7, with the lowered stamping die 26. The stamping strips 27 are introduced far enough into the stamping chambers 23 that the conductors 18 of the longitudinal sides 17b of coils of the second and third winding phases 16b and 16c have also been thrust as far as the bottom 23a of the stamping chambers 23. What is essential is that in this way the coil conductors 18 of the three winding phases 16, after all the coils 17 have been placed in the stamping chambers 23, are deformed in common in the region of the longitudinal sides 17b of coils in such a way that they are aligned parallel with one another and resting on one another in pairs. In addition, the coil conductors 18, in the region of the winding heads 17c, are internested in their crossing regions by the two holding-down strips 28 of the stamping die 26. The winding head thickness of the individual coils is reduced in the process to approximately half the slot depth or coil height. It is also essential that in the process the elastic stresses inside the coils are largely cancelled out, without any cross-sectional deformation of the coil conductors, and that the coil conductors in the region of the winding heads, because of their variable projection are internested inside one another so that in the crossing regions of the winding heads as well, the conductors mesh with one another and are intertwined with one another. In this way, a highly dimensionally stable stator winding is obtained that is safe and secure to handle in the further course of production of the electrical machine.

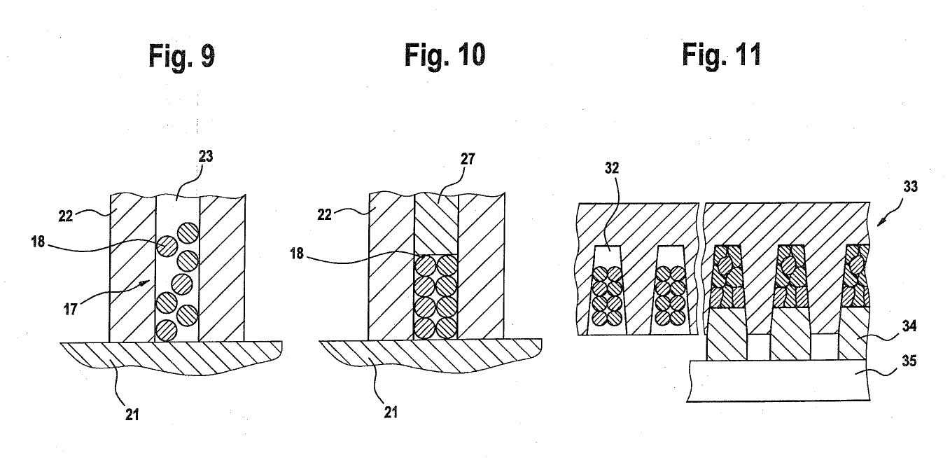

FIG. 9 shows an enlarged fragment of the stamping matrix 20 with a stamping chamber 23 and a coil 17 loosely inserted in the stamping chamber; the total of eight conductors 18 of this coil are still not in order and some of them are spaced apart from one another. FIG. 10 shows the same fragment of the stamping matrix 20 with the stamping strip 27 of the stamping die 26 lowered into the stamping chambers 23. It can be seen there that now all eight conductors 18 of the coil 17 are aligned and fixed in a controlled position, without any spacing from one another, in pairs side by side and in four layers one above the other.

For further processing of the stator winding 14, the stator winding, after the stamping die 26 has been raised, is now removed from the stamping matrix 20 and transferred to a post-stamping station 33, which is shown enlarged in a fragment in FIG. 11. There, the coils 17 of the stator winding 14, with their conductors 18 aligned as shown in FIG. 10, are placed in stamping slots 32 in the post-stamping station 33; the cross section of these slots essentially corresponds to the final slot cross section of the stator lamination packet 13 of the electrical machine 10. The enamel-insulated conductors 18 are then deformed in their cross section in a known manner, with suitable strips 34 of a stamping tool 35, in such a way that the cross section of the winding head slots is imparted to the longitudinal sides of coils 17, in order to attain a high slot fill factor.

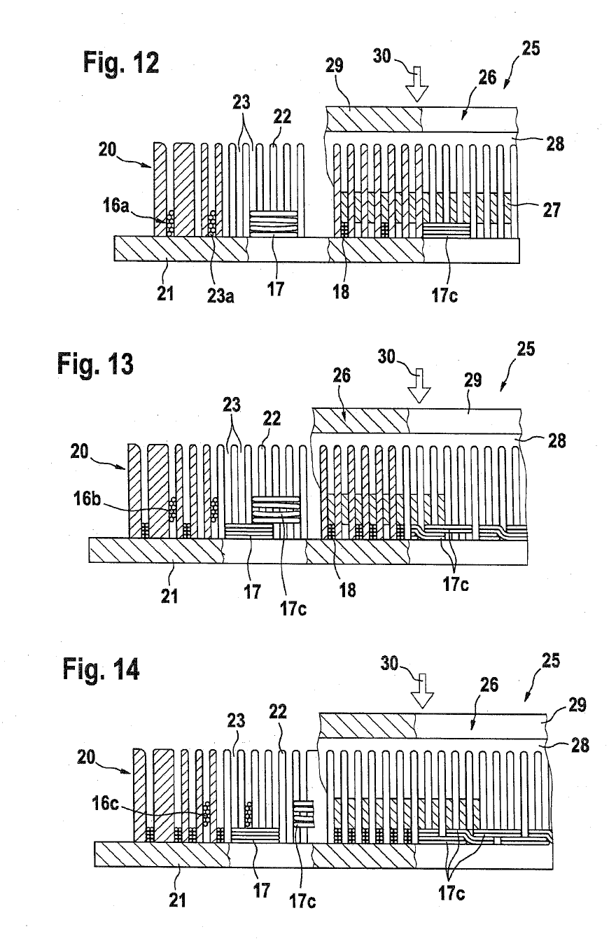

FIGS. 12 through 14 show the method for prestamping the stator winding 14 in a second exemplary embodiment, in a somewhat modified order of steps. In the left half of FIG. 12, the coils 17 of a first winding phase 16a of the stator winding 14 are loosely placed in the stamping chambers 23 of the stamping matrix 20, and the lower winding layer is braced on the bottom 23a of the stamping chambers 23. The left portion of FIG. 12 is shown in cross section. Next, the stamping die 26 is positioned above the stamping matrix 20 and—as shown in the right half of FIG. 12—lowered in the direction of the arrow 30, so that the stamping strips 27 of the stamping die 26 move into the stamping chambers 23 down to their lower position. In the process, the coil conductors 18 are aligned parallel with one another without cross-sectional deformation, so that as shown in FIG. 10 they are clamped firmly in the stamping chambers 23, in pairs side by side and in four layers one above the other. The winding heads 17c are compressed to the single coil height by the holding-down strips 28 of the stamping die 26.

After that, as shown in FIG. 13, the second winding phase 16b is loosely placed in the stamping matrix 20, offset from the first winding phase 16a that has been left there. The coils of this winding phase are braced with their winding heads 17c on the winding heads of the lower winding phase 16a. The stamping die 26, shown partly in cross section, is now positioned once again—as can be in seen in the right half of FIG. 13—above the stamping matrix 20, and its stamping strips 27 are again lowered in the direction of the arrow 30 into the stamping chambers 23 down to the lower position. Now the coil conductors 18, in the region of what are now the crossing winding heads 17c, are internested and entwined with one another because of their different projection length. At the same time, coil conductors 18 in the region of the longitudinal sides 17b of coils of the second winding phase 16b are pressed by the stamping strips 27 against the bottom 23a of the stamping chambers 23 in the same way as for the first winding phase 16a, and in the process are aligned parallel with one another as shown in FIG. 10. In the process, the winding heads 17c are reduced to approximately half the coil height by the holding-down strips 28 of the stamping die 26, because of the variable projections of their conductors. In the right portion of FIG. 13, it can be seen that the conductors 18 are partly deformed and internested. Both winding phases are now left in the stamping matrix 20, and as shown in FIG. 14, in the left half, the third winding phase 16c is now inserted loosely, offset from the winding phases 16a and 16b, into the stamping chambers 13 of the stamping matrix 20; once again, the coils 17 are braced with the winding heads 17c on the winding heads located beneath them of the winding phases 16a and 16b. As shown in the right half of FIG. 14, the stamping die 26 is once again positioned above the stamping matrix 20 and lowered with its stamping strips 27 into the stamping chambers 23 in the direction of the arrow 30. In the process, all the coils of the three winding phases 16 are now prestamped jointly. As a result, on the one hand the conductors 18 of the longitudinal sides 17b of coils of the third winding phase 16c are pressed against the bottom 23a of the stamping chambers 23 and in the process aligned parallel with one another in accordance with FIG. 10. In addition, the winding heads 17c are stamped into their final shape by the holding-down strips 28 of the stamping die 26, without deformation of the conductor cross sections, and as shown in the right portion of FIG. 14 are internested and entwined with one another at approximately half the coil height. The stator winding, now completely prestamped, is then removed from the pre-stamping station and handled further in a post-stamping station 33 as shown in FIG. 11.

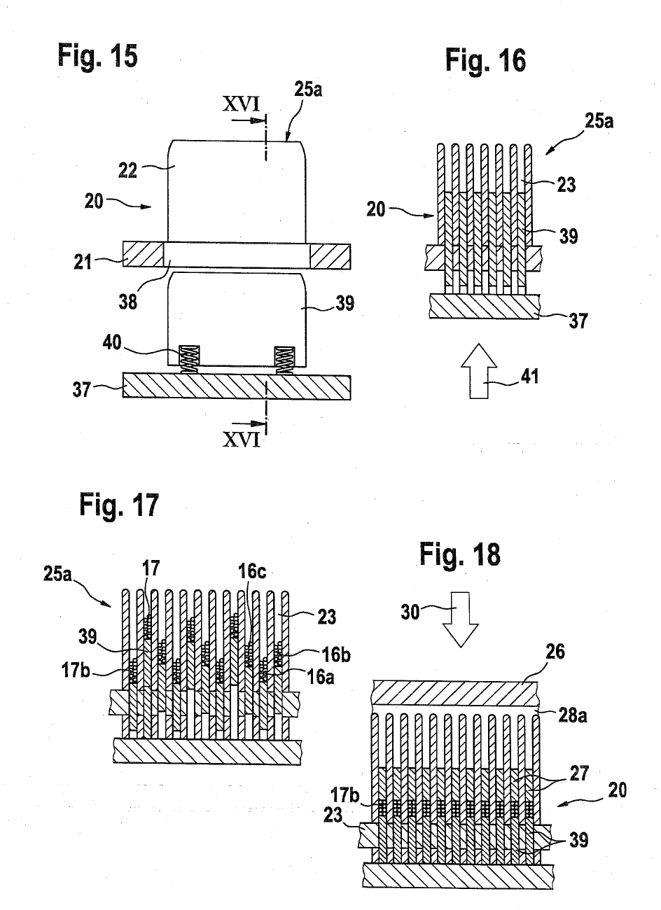

FIGS. 15 through 18 show a further exemplary embodiment with a re-equipped pre-stamping station. Since in the previous two exemplary embodiments the coils of the second and third winding phases 16b and 16c, on placement in the stamping chambers 23, are braced solely on the winding heads of the winding phase located beneath, and thus the lower conductors are suspended freely in the region of the longitudinal sides of coils in their stamping chambers 23, there is the risk that the initially still elastically prestressed conductors will partly cross one another and will maintain that position even upon being lowered down to the bottom 23a of the stamping chambers 23 and can then be squeezed finally by the stamping strips 27 in the region of such line crossings, with the risk of cross-sectional constrictions and damage to the enamel insulation of the conductors 18. This risk can be reduced markedly by a reinforcement of the coils 17 in the stamping chambers 23 during the entire operation of lowering the stamping die 26. In FIG. 15, a base plate 37 which in its dimensions is essentially equivalent to those of the stamping plate 21 is located below the stamping matrix 20, shown in cross section, of the prestamping apparatus 25a. The stamping plate 21 is provided here, in the region of the stamping chambers 23, with bottom openings 38, below which bottom plates 39 are located that are secured to the base plate 37 and held by spring elements 40 in an upper outset position.

FIG. 16 shows a fragment of the prestamping apparatus 25a in a front-end view in cross section along the line XVI-XVI of FIG. 15, with the base plate 37 moved upward in the direction of the arrow 41. The bottom plates 39 of the base plate 37 protrude through the bottom openings 38 in the stamping plate 21 as far as an upper position into the stamping chambers 23, which represents an outset position for the prestamping of the stator winding 14. Now, in a manner similar to FIG. 5 in the first exemplary embodiment, the three winding phases 16 of the stator winding 14 can be inserted with their coils 17 into the stamping chambers 23 of the stamping matrix 20 in succession.

FIG. 17 shows a cross section through a part of the prestamping apparatus 25a of FIG. 16, but with winding phases 16a, 16b and 16c inserted. Upon the insertion of the longitudinal sides 17b of coils into the stamping chambers 23, the bottom plates 39 are pressed backwards spring-elastically to different heights in the stamping chambers 23, depending on the particular position of the phase windings 16. As a result, the adjacent coils 17 of the three winding phases 16 are initially kept at a graduated height and braced in the region of their longitudinal sides 17c. After that, as shown in FIG. 18, the stamping die 26 is positioned above the stamping matrix 20 and lowered in the direction of the arrow 30. The stamping strips 27 moving into the stamping chambers in the process then initially align the conductors of the longitudinal sides of coils of the upper winding phase 16c parallel with one another, before the bottom plates 39 located below them yield spring-elastically. The same happens again, upon further lowering of the stamping strips 27, at the longitudinal sides of coils of the second winding phase 16b, until finally the longitudinal sides of coils of the lower winding phase 16a have also been grasped, aligned parallel with one another, and fixed by the stamping strips 27.

FIG. 18 shows the final position of the conductors 18 in the region of the longitudinal sides 17b of coils in cross section. It can be seen that the bottom plates 39, which now form the bottoms of the stamping chambers 23, have not been lowered spring-elastically to a common lower level until the alignment of the longitudinal sides of coils and the deformation of the winding heads take place, this lower level here being located somewhat above the stamping plate 23. As a result, it is possible for the winding heads on both sides of the coils 17 to be pressed downward somewhat farther, as far as the stamping plate 21, by suitably shaped holding-down strips 28a of the stamping die 27, so that upon later assembly of the electrical machine, more space is obtained for the fans to be mounted on the claw pole rotor 15.

Once again, the stator winding, now prestamped with a stable shape, after the stamping die 26 is raised and the base plate 37 with the bottom plates 39 of the stamping matrix 20 has been lowered, is removed and delivered to the post-stamping station 33, where as shown in FIG. 11 the coil conductors 18 are deformed in their cross section, in the region of the longitudinal sides 17b of coils, in such a way that the coil cross section corresponds with the later slot cross section of the lamination packet. After that, the stator winding, stamped in final form, is placed using a known technique in the slots of a prefabricated stretched-out lamination packet, and the lamination packet along with the stator winding is bent into a stator ring and fixed.

In the prestamping according to the invention of the stator winding, any wire crossings in the longitudinal sides of coils of the coils 17 are displaced as far as the winding heads, so that the conductors in the slots of the stator lamination packet are aligned parallel with one another. In addition, in the process the conductors in the crossing regions of the winding heads are internested and entwined with one another without cross-sectional deformations. In this way, wire squeezing with a major degree of deformation is avoided.

The invention is not limited, however, to the exemplary embodiments shown. It is equally possible within the scope of the invention for the windings of the individual coils in the region of the winding heads to project variously far in more than two stages, in order in this way optionally to be able to reduce the thickness of the winding heads still further. It is also possible, instead of the single-layer lap winding, to embody the individual winding phases as a multi-layer lap winding or as a single-layer or multi-layer wave winding. If there is a greater number of conductors per slot, then optionally in the pre-stamping station the stamping chambers 23 may be made so wide that at maximum there is even room for three coil conductors. Even if crossings of the conductors in the slot region cannot be completely precluded in that case, this still does not lead to dangerous cross-sectional deformations from squeezing and constriction of the conductors in the crossing region, since because of the parallel alignment of the conductors of the longitudinal sides of coils in the pre-stamping station, the line crossings caused by the coil's springing open are shifted out of the stamping chambers 23 into the winding heads.

1. A method for producing a winding (14), preferably a multi-phase stator winding for electrical machines (10), by which the winding is first made in an automated winder with a predetermined number of coils (17) and a predetermined number of windings, and then, for later insertion into slots of a stator lamination packet (13) of the machine, is stamped in its shape in that the coil conductors (18) each to be inserted into one slot are pressed into the slot shape and reshaped in the region of the longitudinal sides (17b) of the coils, characterized in that the coils (17) are first, in a pre-stamping station (25), placed with their longitudinal sides (17b) in stamping chambers (23) of a stamping slot (20), the width of the stamping chambers (23) being selected such that at least two coil conductors (18) are capable of resting side by side; that then the stamping chambers (23) are approached from above and/or below by a stamping die (26) and/or chamber bottom (23a; 39); that in that process the coil conductors (18) are aligned parallel to one another without cross-sectional deformation; and that after that they are stamped into the final slot shape in stamping slots (32) of a post-stamping station (33) by means of at least partial cross-sectional deformation.

2. The method as defined by claim 1, characterized in that the conductors (18), projecting variously far from the winding heads (17c) of the coils (17), are deformed in the pre-stamping station (25), preferably in the same operation, in such a manner that the winding head thickness of the individual coils (17) is reduced to approximately half the coil height.

3. The method as defined by claim 2, characterized in that the coils (17) of preferably three winding phases (16), offset from one another and each continuously wound, of the winding (14) embodied preferably as a single-layer lap winding are placed in succession in the stamping chambers (23) and deformed in such a way that the conductors (18) in the stamping chambers (23) are aligned parallel to one another and preferably resting in pairs on one another; and that the winding heads (17c) of the coils (17) are internested one inside the other in their crossing regions.

4. The method as defined by claim 3, characterized in that after the insertion of each winding phase (16a, 16b, 16c) into the stamping chambers (23), the conductors (18) of the coils (17) of this winding phase are aligned in the region of the longitudinal sides (17b) of coils and are deformed and internested in the region of the winding heads (17c).

5. The method as defined by claim 3, characterized in that the coil conductors (18) of the three winding phases (16), after the insertion of all the coils (17) into the stamping chambers (23), are jointly aligned in the region of the longitudinal sides (17b) of coils and are deformed and internested one inside the other in the region of the winding heads (17c).

6. The method as defined by claim 1, characterized in that the conductors (18), in the region of the longitudinal sides (17b) of coils, are fixed in the stamping chambers (23) by stamping strips (27) of the stamping die (26), and the bottoms (39) in the stamping chambers (23) are first, before or at the time of the insertion of the coils (17) of the three winding phases (16a, 16b and 16c), kept at a graduated height and are not lowered to a common lower level, preferably being pressed resiliently downward by the stamping die (26), until the alignment of the longitudinal sides (17b) of coils and the deformation of the winding heads (17c) take place.

7. An apparatus for prestamping a winding (14) as defined by claim 1, characterized in that it has a comblike stamping matrix (20) with stamping chambers (23) located side by side that are embodied between upright comb plates (22) extending parallel to one another, the width of the stamping chambers (23) being equivalent to the width of a plurality of coil conductors (18), preferably two of them, located side by side and the height being equivalent to a multiple of the height, preferably more than three times the height, of the conductors resting on one another of one coil (17); that the stamping chambers (23) are closed at the bottom by one bottom (23a, 39) each and are open at the top for insertion of the longitudinal sides (17b) of coils; and that a stamping die (26) is capable of being introduced from above into the stamping chambers (23) and of being lowered in the stamping chambers (23) for parallel alignment of the coil conductors (18).

8. The apparatus as defined by claim 7, characterized in that the stamping die (26) comprises many stamping strips (27) extending parallel to one another, which are secured to a common yoke (29); that the stamping strips (24), after the insertion of the coils (17) into the stamping chambers (23), are positionable above the stamping chambers of the stamping matrix (20) and are lowerable in the stamping direction (30) for prestamping the coils (17).

9. The apparatus as defined by claim 7, characterized in that on each side of the winding heads (17c) of the stamping matrix (20), there is one stop strip (24), such that it fixes the longest one of the variously far-projecting windings of the coils (17) axially; and that the shortest winding of each of the coils (17) is centered and axially fixed by the length of the stamping chambers (23).

10. The apparatus as defined by claim 7, characterized in that on the face ends of the stamping strips (27), extending somewhat outward on both sides past the stamping chambers (23), of the stamping die (26), there is a respective holding-down strip (28, 28a) for deforming the winding heads (17c).

11. The apparatus as defined by claim 7, characterized in that in the outset state of the stamping station (25), bottom plates (39) protruding from below into the stamping chambers (23) are capable of being pushed upward, preferably resiliently, as far as the upper region of the stamping chambers (23) and upon the insertion of the coils (17) are initially partially lowerable and upon prestamping of the coils (17) are lowerable down to a common lower level.

12. An electrical machine, having a winding (14) produced by the method defined by claim 1, characterized in that the coil conductors (18) of the winding (14) in the slots of the stator lamination packet (13) are aligned parallel to one another and in the crossing regions of the winding heads (17c) are internested in one another.
